(19) United States
(12) Patent Application Publication
(10) Pub. No.: US 2007/0008108 A1
(43) Pub. Date: Jan. 11, 2007

(54) Unsynchronized beacon location system and method

(76) Inventors: Alma K. Schurig, Springville, UT (US); Keith Anderson, Springville, UT (US); David L. Mills, Springville, UT (US); David J. Gardner, Springville, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 11/328,698

(22) Filed: Jan. 10, 2006

Related U.S. Application Data
(60) Provisional application No. 60/697,914, filed on Jul. 7, 2005.

(51) Int. Cl. G01S 1/00; G08B 1/08; H04B 7/185; H04Q 7/00

(52) U.S. Cl. 340/539.11; 342/357.1

(57) ABSTRACT

A system comprising a transmitter periodically transmitting a packet via electromagnetic radiation. The packet may be encoded with information and have a length measured in time. The system may further include a receiver comprising an antenna converting incident electromagnetic radiation to an analog electrical current, an analog-to-digital converter receiving the analog electrical current and producing a digital representation thereof, and first and second buffers. Each of the buffers may have a capacity of at least two times the length of the packet. The first and second buffers may store respective first and second copies of the digital representation. The first copy may be offset in time from the second copy by at least the length of the packet.

### RELATED APPLICATIONS

This application claims the benefit of co-pending U.S. Provisional Patent Application Ser. No. 60/697,914, filed on Jul. 7, 2005 for LOCATION SYSTEM AND METHOD.

### BACKGROUND

1. The Field of the Invention

This invention relates to locating and tracking systems and more particularly to novel systems and methods for locating people and physical assets as a function of time.

2. The Background Art

Various systems have been developed to determine the position of objects and people. These systems have been based on a variety of communications technologies. For example, a Global Positioning System (GPS) requires a portable receiver. Each such receiver determines its position by referencing itself to the transmitted signals emitted by an array of earth-orbiting satellites. The receiver reports the calculated position via a display to a user.

For remote reporting of a receiver's position, a GPS receiver must transmit its position. This is typically done using other data communications technology (e.g., cellular telephone systems). GPS equipment has been manufactured for a variety of applications, including survey, mapping, marine, aviation, military, vehicle tracking, and precision farming. Cellular telephones may have GPS chips embedded in them and use the cellular telephone network and airtime to report their position information to a fixed station.

GPS systems have several disadvantages. GPS receivers require significant amounts of power for operation. This increases cost and decreases operating life between charges. GPS systems require a constellation of expensive satellites. Typically, four to six satellites are available at all times to transmit signals to a receiver. Additionally, GPS receivers must rely on expensive communications systems (e.g., cellular telephone systems) to report their location. As may be appreciated, such communication systems may only be located in selected areas. Accordingly, outside ofthose selected areas, a GPS unit cannot communicate its position to an outside entity.

Furthermore, GPS “spoofers” have been designed to simulate and transmit false satellite position information to GPS receivers. Accordingly, the receiver may be manipulated to transmit false location data to an outside entity. Civil GPS signals cannot be encrypted. Moreover, inadvertent and hostile transmitters mayjam the weak satellite signals, thereby denying a GPS receiver correct satellite position data. Other problems associated with GPS systems include shielding of some of the satellites signals by obstuctions, such as trees, buildings, and other structures. Limitations include the need for extremely accurate clocks in the orbiting satellites, and the need for correct Doppler, ephemeral and ionospheric compensation for each satellite's trajectory.

Other current tracking systems include transmitters attached to the object or person being observed. Such transmitters send a signal to a mobile receiver that uses a directional antenna or received signal strength indicator (RSSI) to determine the approximate direction of the transmitter with respect to the receiver. As the receiver moves its position relative to the transmitter, the RSSI increases or decreases with distance. Similarly, the directional antenna reports a stronger signal when pointed in the direction of the transmitter. This type of system has been employed by law enforcement to locate stolen vehicles having special transmitters attached.

However, such transmitter systems are limited in their ability to track multiple transmitters. Accordingly, a receiver must be built into the transmitter to enable an operator to turn on only one transmitter in a given area at a given time. In some situations, the receiver associated with a transmitter may be unable to receive the “on” signal, and the transmitter may never receive the instruction to transmit. Additionally, an operator must be mobile to actively track such transmitters. Moreover, the RSSI may vary directionally as emitted signals interact (e.g. reflect, attenuate) with surrounding vehicles, building, geological formations, or the like.

In view of the foregoing, what is needed is a location detection and tracking system that is inexpensive to create and maintain, is difficult to manipulate or mislead, requires little power, supports tracking of high numbers of objects or persons therewithin, and operates in a frequency band having favorable propagation characteristics.

### BRIEF SUMMARY OF THE INVENTION

In view of the foregoing, in accordance with the invention as embodied and broadly described herein, a method and apparatus are disclosed in one embodiment of the present invention as including a system comprising one or more beacons, three or more locators, at least one server, and one or more clients. Each beacon within the system may periodically transmit an electromagnetic signal in the form of a short signal packet (e.g., one to two millisecond in length). The length of the packets may reduce the possibility of signal collisions within the system. Accordingly, in selected embodiments, many beacons may be included within a system.

The various beacons may control the duration of the off interval (i.e., the time between transmissions) to provide a “duty cycle” permitting classification of the beacon as an intermittent device. This may have two positive effects. First, the duty cycle may minimize power consumption. Second, with appropriate duty cycle selection, beacons in accordance with the present invention may legally transmit within L Band and Ultra High Frequency (UHF) bands, which provide favorable propagation characteristics.

The locators within the system may be arranged to receive an incident electromagnetic signal. Accordingly, within the incident signal, the locators may receive the signal packets emitted by the various beacons.

In selected embodiments, each locator may process the incident signal received thereby. This processing may include filtering, frequency conversion, amplification, analog-to-digital conversion, timestamping to identify a time of receipt for any signal packets contained in the incident signal, and the like, or some combination thereof. The information extracted from the incident signal may be encoded within a processed signal. The processed signals may then be passed from the respective locators to the server for further analysis.

A server in accordance with the present invention may analyze the various processed signals received to determine or extract information corresponding to each of the various beacons. For example, the server may determine the location of each beacon. In one embodiment, the location of each beacon may be determined using propagation time difference. That is, a server may use the differences in reception time of a particular signal packet by the various locators to determine the location of the beacon emitting that signal.

In selected embodiments, signals emitted from a beacon may communicate certain status information. For example, the signals may include user information such as heart rate, blood pressure, alarm, solicitation of assistance, or the like. When a beacon is applied to an inanimate object, the signals may include status information corresponding to that object. Additionally, the signals may include or transmit status information corresponding to the beacon itself. For example, the signals may include information on battery life, malfunctions, tampering, removal, or the like.

In certain embodiments, it may be desirable to synchronize the various locators. Synchronization may be necessary to provide an accurate and consistent timestamp of incident signals. Accordingly, each of the locators may be equipped to transmit communication signals. Such signals may provide a mechanism for synchronization between the locators.

A server in accordance with the present invention may communicate with one or more clients. Such clients may receive certain information from the server. For example, a client may receive information regarding the location of one or more beacons. Similarly, the client may receive information regarding the status of the user of a beacon.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic diagram illustrating one embodiment of a system in accordance with the present invention comprising a beacon, three locators, a server, and two clients.

FIG. 2 is a schematic block diagram illustrating one embodiment of a beacon in accordance with the present invention;

FIG. 3 is a block diagram illustrating one method of operation for a beacon in accordance with the present invention;

FIG. 4 is a schematic diagram illustrating one embodiment of a signal emitted by a beacon in accordance with the present invention;

FIG. 5 is a schematic block diagram illustrating one embodiment of a locator in accordance with the present invention;

FIG. 6 is a block diagram illustrating one method of operation for the receiver of a locator in accordance with the present invention;

FIG. 7 is a schematic diagram illustrating selected components and flows of data within the receiver of a locator in accordance with the present invention;

FIG. 8 is a block diagram illustrating one method of operation for a locator in accordance with the present invention;

FIG. 9 is a block diagram illustrating one method for mitigating jamming signals in accordance with the present invention;

FIG. 10 is a block diagram illustrating one method for resolving and applying a timestamp in accordance with the present invention;

FIG. 11 is a schematic block diagram illustrating one embodiment of a digital signal processor in accordance with the present invention;

FIG. 12 is a schematic block diagram illustrating one embodiment of a server in accordance with the present invention;

FIG. 13 is a schematic block diagram illustrating selected software modules that may be supported by a server in accordance with the present invention;

FIG. 14 is a schematic diagram illustrating selected equations that may be used to calculate a two-dimensional location in accordance with the present invention;

FIG. 15 is a schematic diagram illustrating selected equations that may be used to calculate a three-dimensional location in accordance with the present invention;

FIG. 16 is a block diagram illustrating a first method for synchronizing the clocks of the various locators included within a system in accordance with the present invention;

FIG. 17 is a block diagram illustrating a second method for synchronizing the clocks of the various locators included within a system in accordance with the present invention; and

FIG. 18 is a block diagram illustrating a third method for synchronizing the clocks of the various locators included within a system in accordance with the present invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of a system and method in accordance with the present invention, as represented in the drawings, is not intended to limit the scope of the invention, as claimed, but is merely representative of various embodiments of systems consistent with the invention. The illustrated embodiments of apparatus and methods in accordance with the invention will be best understood by reference to the drawings, wherein like parts are designated by like numerals throughout.

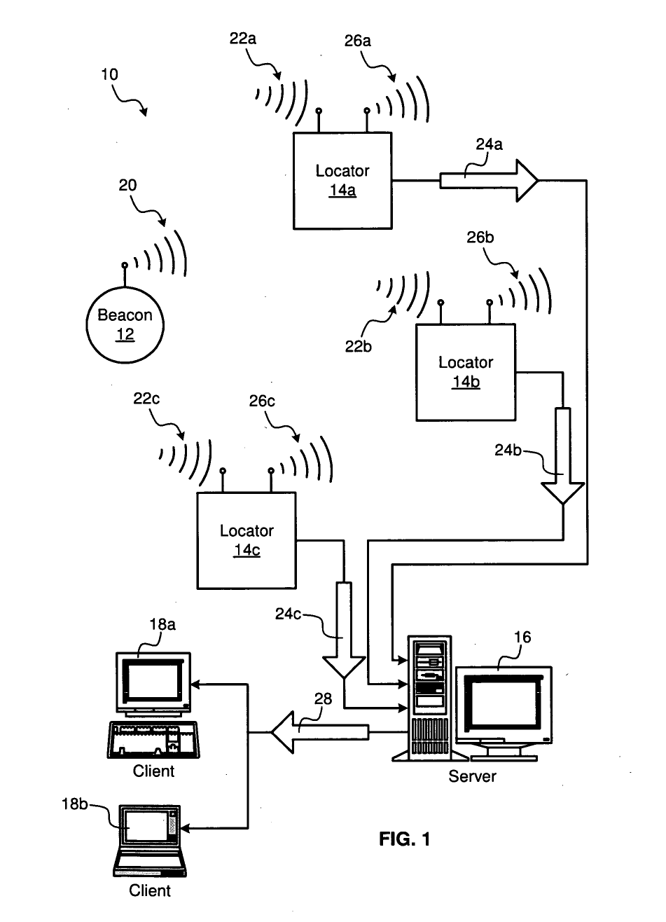

Referring to FIG. 1, a system 10 in accordance with the present invention may include one or more beacons 12, three or more locators 14, a server 16, and one or more clients 18. Each beacon 12 may periodically transmit an electromagnetic signal 20. The locators 14 may be arranged to receive incident electromagnetic radiation 22 (incident signal 22). Accordingly, within the incident signal 22, the locators 14 may receive the signals 20 emitted by a beacon 12.

In selected embodiments, each locator 14 may process the incident signal 22 received thereby to produce a processed signal 24. This processing may include filtering, frequency conversion, amplification, analog-to-digital conversion, timestamping, and the like, or some combination thereof. The processed signal 24 may then be passed from the respective locators 14 to the server 16 for further analysis.

The transfer of the processed signal 21 from the locators 14 to the server 16 may be accomplished in any suitable manner. For example, in selected embodiments, the locators 14 may transmit the processed signal 24 to the server 16 via a hard wire network. In other embodiments, the locators 14 may transmit the processed signal 24 to the server 16 via a wireless network. In still other embodiments, the locators 14 may transmit the processed signal to the server 16 via a network employing both hard wire and wireless elements or portions. Accordingly, the processed signal 24 may be passed to the server 16 without regard to the distance between the locators 14 and the server 16.

A server 16 in accordance with the present invention may analyze the various processed signals 24a, 24b, 24c received to determine or extract information corresponding to each of the various beacons 12. For example, the server 16 may determine the location of each beacon 12. In one embodiment, the location of each beacon 12 may be determined using a propagation time difference. That is, a server 16 may use the differences in reception time of a particular signal 20 by the various locators 14 to determine the location of the beacon 12 emitting that signal 20.

In selected embodiments, a server 16 may communicate back to one or more locators 14 the most probable location for one or more of the beacons 12 in the system 10. The server 16 may make such predictions based on the last known locations, directions of travel, and speed. Such information may be stored by the various locators 14 and used to support refined location calculations in the future.

In selected embodiments, signals 20 emitted from a beacon 12 may communicate certain status information. In some embodiments, the signals 20 may include or transmit status information corresponding to a user of the beacon 12. For example, the signals 20 may include information on heart rate, blood pressure, alarm, solicitation of assistance, or the like. When a beacon 12 is applied to an inanimate object, the signals 20 may include status information corresponding to that object. For example, a beacon 12 applied to an automobile may include speed, engine temperature, revolutions-per-minute, or the like.

In some embodiments, the signals 20 may include or transmit status information corresponding to the beacon 12 itself. For example, the signals 20 may include information on battery life, malfunctions, tampering, removal, or the like.

In certain embodiments, it may be desirable to synchronize the various locators 14. For example, synchronization may be necessary to provide an accurate and consistent timestamp of incident signals 22. Locators 14 may be synchronized in any suitable manner using any suitable mechanism. In selected embodiments, each of the locators 14 may be equipped to transmit communication signals 26. Such signals 26 may provide a mechanism for synchronization between the locators 14. Additionally, in some embodiments, communication signals 26 may provide the mechanism through which a processed signal 24 is transmitted from the locators 14 to the server 16. If desired or necessary, communication signals 26 may be encrypted by the respective locators 14 before transmission to the server 16.

A server 16 in accordance with the present invention may communicate with one or more clients 18. Such clients 18 may receive certain information 28 from the server 16. For example, a client 18 may receive information 28 regarding the location of one or more beacons 12. Similarly, the client 18 may receive information 28 regarding the status of the user of a beacon 12.

In selected embodiments, the clients 18 may correspond to computers or computer systems. In other embodiments, the clients 18 may correspond to human beings receiving the desired information 28 directly from the server. If desired, the clients 18, or the entities utilizing the clients 18, may compensate the operator or operators of the system 10 for the information 28 received.

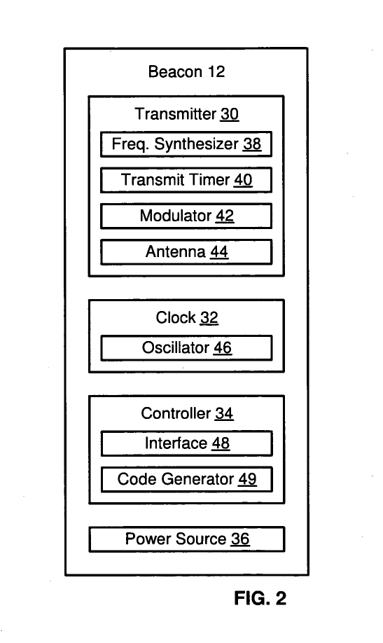

Referring to FIG. 2, in selected embodiments, a beacon 12 in accordance with the present invention may include a transmitter 30, clock 32, controller 34, power source 36, or any other desired or necessary subsystem or combination of subsystems. In certain embodiments, a transmitter 30 may include a frequency synthesizer 38. A frequency synthesizer 38 may be primarily responsible for generating the carrier signal forming the base of any signals 20 emitted by the transmitter 30. If desired or necessary, a frequency synthesizer 38 may include a frequency multiplier. For example, if the clock 32 produces a ten megahertz oscillation, and a transmitter 30 is to run at a carrier frequency of three hundred sixty megahertz, then a frequency synthesizer 38 with a thirty-six times multiplier may receive the oscillations from the clock 32 and generate a three hundred sixty megahertz carrier signal.

In selected embodiments, a transmitter 30 may include a transmit timer 40. A transmit timer 40 may count bits to control the duration of a transmission (i.e., define the size of a signal packet). In some embodiments, a transmit timer 40 may limit a transmission to one to two millisecond. Such an arrangement may allow multiple transmitters 30 to share a single carrier frequency by decreasing the opportunity for collision or overlap.

A transmit timer 40 may also control the duration of the off interval (i.e., the time between transmissions). This off interval may be selected to provide a “duty cycle” permitting classification of the transmitter 30 as an intermittent device. However, the duty cycle may still be such that signals 20 are emitted from a beacon 12 with sufficient frequency to provide the desired granularity of location determination or information retrieval. In selected embodiments, a transmit timer 40 may randomize the off interval within a selected range to decrease the probabilities of collisions.

In selected embodiments, a transmitter 30 may include a modulator 42. A modulator 42 may selectively alter a carrier signal to encode it with information. The modulation techniques used by a modulator 42 may include Phase-Shift Keying (PSK), Amplitude-Shift Keying (ASK), Frequency-Shift Keying (FSK), Bi-Phase Shift Keying (BPSK), Continuous Wave (CW), Orthogonal Frequency Division Modulation (OFDM), Quadrature Amplitude Modulation (QAM), or the like.

To provide access for a plurality of transmitters 30, modulators 42 in accordance with the present invention may employ one or more multiple access modulation and transmission techniques. For example, a modulator 42 may use Time Division Multiple Access (TDMA), Frequency Division Multiple Access (FDMA), Code Division Multiple Access (CDMA) using Frequency Hopping Spread Spectrum (FHSS) or Direct Spread Spread Spectrum (DSSS), or the like. The TDMA and FDMA techniques may be particularly useful as they provide a decreased statistical probability of collision and an increased tolerance for collisions. This may permit operation of a greater number of transmitters 30 in a given area.

A transmitter 30 in accordance with the present invention may include an antenna 44 of any suitable type. In selected embodiments, such an antenna 44 may have extended horizontal gain and polarization properties consistent with those of the corresponding locators 14. For highly accurate systems 10, the phase center coordinates of an antenna 44 may represent the location that is actually determined for the corresponding transmitter 30.

The antenna 44 may be selected according to the intended environment of use, the design of the transmitter 30, the carrier frequency, or the like. An antenna 44 in accordance with the present invention may be embedded or external. An antenna 44 may also be vertically, horizontally, or circularly polarized. If desired or necessary an antenna 44 may have multiple elements. Additionally, if desired or necessary, an antenna 44 may be directional.

A beacon 12 in accordance with the present invention may include any suitable clock 32. Using the methods of the present invention, a clock 32 need not be synchronized to any real time reference. Accordingly, the clock 32 need only be sufficiently stable to regulate in the operations of the beacon 12.

As a result, beacons 12 in accordance with the present invention do not require highly stable oscillators 46 (e.g., those having short term stability of 10E-14 seconds). Instead, clocks 32 in accordance with the present invention may rely on a low cost oscillator 46 having the desired stability. For example, in some embodiments, a quartz oscillator 46 having a short term (e.g., one millisecond) stability of about ten nanoseconds may be sufficient.

In certain embodiments, a transmitter 30 may include a controller 34. A controller 34 may oversee and control the overall operation of the other subsystems 30, 32, 36 of the beacon 12. In some embodiments, a controller 34 may include an interface 48. Through such an interface 48, the controller 34 may receive status information such as alarm conditions, vital statistics, logistical signals, or the like. Such information may be encoded within the signals 20 emitted by the beacon 12, thereby communicating the status information to the appropriate client 18.

An interface 48 may receive status information manually (e.g., push buttons) or electronically (e.g., a communication port). For example, law enforcement personnel may arrange a sensor suite to provide electronic data to an interface 48. Depending on the nature of the various sensors within the suite, the controller 34 may monitor vitals and other status information. Accordingly, the location and functionality of law enforcement personnel or equipment may be monitored at all times.

Similarly, a patient requiring a life link to a medical service provider may arrange a sensor suite to provide electronic data to an interface 48. In such an embodiment, should a medical emergency arise, the medical service provider may quickly be notified. In other embodiments, an interface 48 may be equipped with an alarm button notifying the medical service provider, law enforcement, or the like of an emergency or suspected danger.

In still other embodiments, a trucking company may equip some or all of its vehicles with a sensor suite monitoring vehicle speed, engine temperature, location, or the like. Such a suite may provide electronic data to an interface 48. Accordingly, the trucking company may be notified when one of its vehicles exceeds a selected speed, overheats, goes off route, or the like. Thus, in addition to deriving location information, a significant amount of status information may be collected and reported by a system 10 in accordance with the present invention.

In certain embodiments, an interface 48 may be operably connected to the transmit timer 40 or other operating parameters regulated by the controller 34 (e.g., pseudo noise code selections, chip rates, carrier frequency, or the like). Accordingly, authorized personnel may selectively control certain functionality of the beacon 12.

In selected embodiments, a beacon 12 may encrypt outgoing signals 20. If desired, the controller 34 may perform such encryption. Additionally, a beacon 12 may include a code generator 49. Such a code generator 49 may create certain portions of the emitted signal 20. For example, the code generator 49 may create a pseudo noise portion of the outgoing signal 20. In certain embodiments, a code generator 49 may be embodied within the hardware or software of a controller 34. In some embodiments, to facilitate signal processing by the locators 14, a beacon 12 may precisely lock the carrier frequency produced by the frequency synthesizer 38 to the chip rate associated with the code generator 49 through the use of frequency synthesis logic.

In certain embodiments, a code generator 49 may modulate a transmitter 30 to run at a chip rate of one million ones or zeros in a binary pulse code communicated per second by dividing the oscillator 46 of a clock 32 by some number (e.g., ten), or by dividing the carrier frequency of the transmitter 30 by three hundred sixty. This may provide coherent modulation by the modulator 42. Similarly, a modulator 42 may further coherently divide a one megahertz chip rate output from the clock 32 by thirty-two, twenty, or sixteen, which would set the number of data bits in an approximate one millisecond transmission thirty-one, fifty, and sixty-two bits, respectively.

A beacon 12 in accordance with the present invention may include any suitable power source 36. Characteristics that may be considered when selecting a power source 36 may typically include cost, size, weight, reliability, duration, rechargability, and the like.

In selected embodiments, a power source 36 may comprise a battery, permitting the beacon 12 to function without external power sources. In other embodiments, a power source 36 may simply comprise a connection connecting abeacon 12 to some external power source related to its environment or host system (i.e., a vehicle, building, or equipment to which a beacon 12 may secure). In still other embodiments, a power source 36 may comprise a battery 37 providing power to the beacon 12 only after the beacon 12 has been separated from an external power source.

A beacon 12 in accordance with the present invention may be embodied or included within any suitable form or structure. Such forms or structures may be selected according to requirements of the intended use. For example, in selected embodiments, a beacon 12 configured as a band for encircling a wrist, ankle, or the like. In some embodiments, such bands may resist removal. Similarly, the bands may provide a mechanism for detecting removal.

For example, a band may include a conductor embedded therein. Accordingly, if the band were cut off, stretched to pass over a foot or hand, or the like, the electrical resistance of the conductor may change. This change may be detected by a controller 34 and reported by a beacon 12. Accordingly, interested clients 18 may be informed that the beacon 12 is being or has been compromised. Very thin conductors can be embedded such as to break or fail if tampered with by one seeking to defeat or circumvent them.

In other embodiments, a beacon 12 may be embodied as a tag. Such a tag may be worn on a necklace, clipped to hardware, or the like. In still other embodiments, a beacon 12 in accordance with the present invention may be embodied in still other forms or included within still other structures.

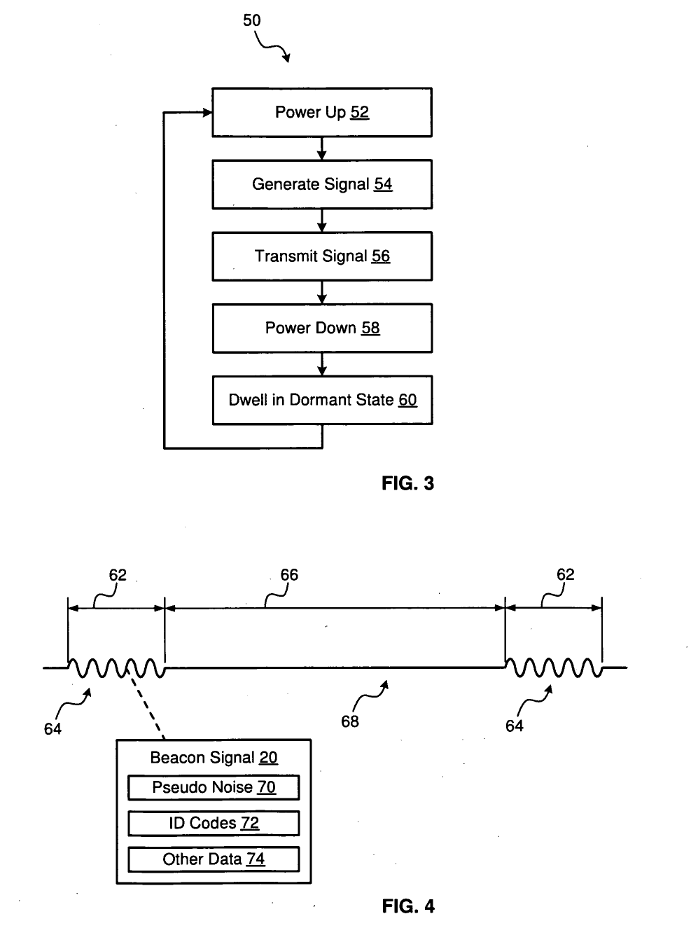

Referring to FIG. 3, the power consumption mode of a beacon 12 in accordance with the present invention may determine the necessary specifications of the power source 36. For example, the power consumption modes may determine the size of battery required and how long it may last before recharge or replacement. Example power consumption modes may include off, sleep (dormant), wake, interface monitoring, transmission length adjustment, off interval adjustment, long data word, short data word, high transmission power, low transmission power, or the like.

For example, in selected embodiments, a method 50 of operating a beacon 12 in accordance with the present invention may begin when the beacon 12 is powered up 52. After power up 52, the beacon 12 may generate 54 and transmit 56 a signal 20. After the signal is transmitted 56, the beacon 12 may power down 58 to conserve power resources. Accordingly, the beacon 12 may dwell 60 in a dormant state (sleep mode) characterized by minimal power consumption. When the time arrives to send the next signal 20, the beacon 12 may again power up 52, and the process 50 may continue.

Referring to FIG. 4, in selected embodiments, the duty cycle of a transmitter 30 may be adjusted to minimize power consumption. That is, the duration 62 of the signal packet 64 (i.e., the size or length of the transmit interval) may be pushed toward a minimum, while the duration 66 of the off or silent interval 68 may be pushed toward a maximum.

For example, a transmit timer 30 may dictate a signal packet 64 having a duration 62 of one millisecond and a silent interval 68 having a duration 66 of ten seconds. That is, the transmitter 30 may be transmitting only 0.01% of the time. In such an embodiment, a two Watt peak transmission power or effective radiated power (ERP) may result in less than two hundred microwatts of average power consumption. Accordingly, a power source 36 may comprise a small battery and still provide sufficient power to last for a significant periods of time (e.g., months) at less than one milliwatt of average power consumption.

Moreover, modern digital circuitry consumes very little power when dwelling 60 in a dormant state. In the transition between sleep 60 and transmit mode 52, 54, 56, any suitable sequence of operations may be followed to insure proper or adequate stabilization of frequency synthesizers 38 and the like. Accordingly, before any signal is transmitted 56, a stable transmission frequency and chip rate may be ensured.

The signals 20 generated by a beacon 12 in accordance with the present invention may include any suitable arrangement of data. For example, in selected embodiments, a single signal 20 may include pseudo noise 70 (PN), one or more identification codes 72, as well as any other data 74 necessary or desired (e.g., status information on a user, status information of the beacon 12, or the like).

In selected embodiments, unique identification codes 72 may permit identification of each transmitting beacon 12. That is, the identification code 72 communicated by a particular beacon 12 may distinguish that beacon 12 from all others. If desired, selected identification codes 72 may be encrypted. The nature and extent of such encryption may be selected to prevent “spoofing” of a beacon 12 by unauthorized transmitters.

In selected embodiments, to further reduce transmission errors caused by noise or interference, a Cyclical Redundancy Check (CRC) may be appended to the signal 20. The CRC may be of sufficient complexity to cover the identification codes 72 and other data 74. Alternatively, a Forward Error Correction (FEC) algorithm may be applied to the identification codes 72, with an attendant increase in transmission duration 62.

To further improve the probability of valid reception, the transmitter 30 may repeatedly transmit a particular signal 20. In selected embodiments, this repetition may occur with a single transmission interval 62. Alternatively, the repeated signals 20 may be spaced by some delay and potentially by the entire duration 66 of the silent interval.

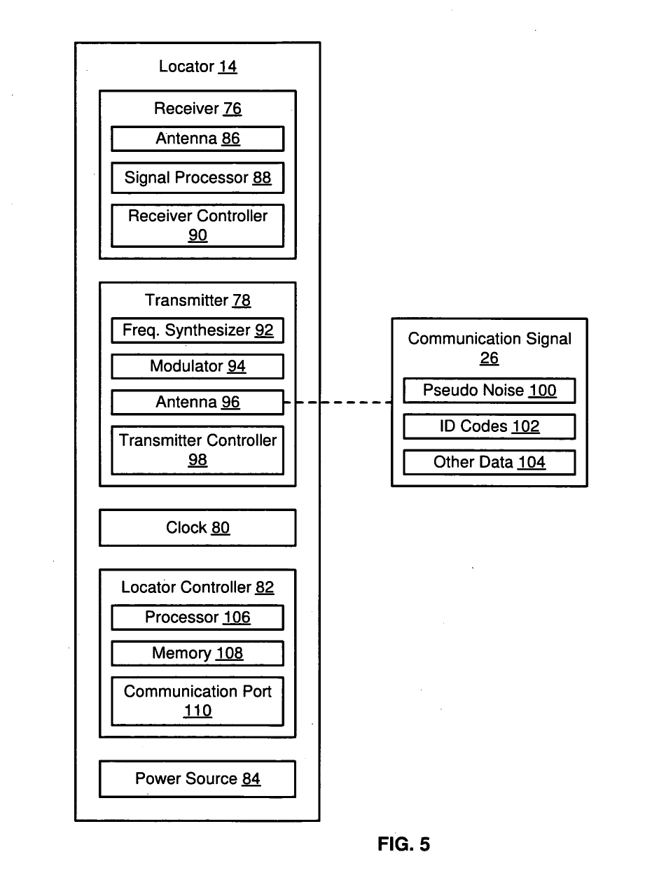

Referring to FIG. 5, a locator 14 in accordance with the present invention may include a receiver 76, transmitter 78, clock 80, controller 82, power source 84, or any other desired or necessary subsystem or combination of subsystems. In selected embodiments, the receiver 76 may be primarily responsible for receiving the incident signal 22. Accordingly, a receiver 76 may include an antenna 86.

The antenna 86 of a receiver 76 may be vertically, horizontally, or circularly polarized. The antenna 86 may be embedded or external. Additionally, the antenna 86 may comprise a single element or a multi-element array. In selected embodiments, the antenna 86 of a receiver 76 may be selected to improve signal gain from certain transmitters 30, 78, while rejecting unwanted signals (e.g., noise, electromagnetic interference (EMI), radio frequency interference (RFI), jamming signals, spoofing signals, other cluttering legitimate signals, or the like).

In certain embodiments, it may be desired or necessary for a receiver 76 to process the incident signal 22. Accordingly, a receiver 76 may include a signal processor 88. A signal processor 88 may include the hardware, software, or the like necessary to condition the incident signal 22 and generate the processed signal 24 in a form acceptable by the server 16. For example, in selected embodiments, a receiver 76 may include the hardware, software, or the like necessary to process a signal 22 through filtering, frequency conversion, amplification, analog-to-digital conversion, timestamping, and the like, or some combination thereof.

In selected embodiments, a receiver 76 may include a receiver controller 90. A receiver controller 90 may oversee and control the overall operation of the other subsystems 86, 88 of the receiver 76. The receiver controller 90 may also facilitate communication between the receiver 76 and the other subsystems 78, 80, 82, 84 of the locator 14.

A transmitter 78 of locator 14 may be primarily responsible for generating and transmitting communication signals 26 to the other locators 14. In certain embodiments, these communication signals 26 may be used to synchronize the locators 14 and provide accurate and reliable timestamps. If desired or necessary, these communication signals 26 may also be used to carry the processed signal 24 from a locator 14 to a server 16.

The transmitter 78 of a locator 14 in accordance with the present invention may include a frequency synthesizer 92. A frequency synthesizer 92 may be primarily responsible for generating the carrier signal forming the base of any signals 24 emitted by the transmitter 78. If desired or necessary, a frequency synthesizer 92 may include a frequency multiplier converting any frequency generated by the clock 80 to the desired frequency for the communication signals 26.

In selected embodiments, a transmitter 78 may include a modulator 94. A modulator 94 may selectively alter a carrier signal to encode it with information. The modulation techniques used by a modulator 94 may include, for example, PSK, ASK, FSK, BPSK, CW, OFDM, QAM, or the like. To provide access for a plurality of transmitters 78, modulators 94 in accordance with the present invention may employ TDMA, FDMA, CDMA using FHSS or DSSS, or the like.

A transmitter 78 may also include an antenna 96 of any suitable type. In selected embodiments, the antenna 96 of a transmitter 78 may be the same antenna 86 used by the receiver 76. That is, the receiver 76 and transmitter 78 of a single locator 14 may share an antenna 86, 96. Alternatively, due to differences in frequency between the signals 20 received by the receiver 76 and the signals 26 emitted by the transmitter 78, as well as other considerations, it may be preferable to utilize two separate antennas 86, 96. In such embodiments, both antenna 86, 96 may be tuned to their particular requirements.

The antenna 96 of a transmitter 78 may be selected according to the intended environment of use, the design of the transmitter 78, the carrier frequency of the communication signals 26, or the like. Accordingly, such an antenna 96 may be embedded or external, vertically, horizontally, or circularly polarized, or have a single element or multiple elements. Additionally, if desired or necessary, such an antenna 96 may be directional.

In selected embodiments, a transmitter 78 may include a transmitter controller 98. A transmitter controller 98 may oversee and control the overall operation of the other subsystems 92, 94, 96 of the transmitter 78. The transmitter controller 98 may also facilitate communication between the transmitter 78 and the other subsystems 76, 80, 82, 84 of the locator 14.

The communication signals 26 generated by the transmitter 78 of a locator 14 in accordance with the present invention may include any suitable arrangement of data. For example, in selected embodiments, a single communication signal 26 may include pseudo noise 100, one or more identification codes 102, as well as any other data 104 necessary or desired. In certain embodiments, other data 104 may include status information corresponding to the locator 14. For example, the other data 104 may include information regarding malfunctions, tampering, location of the locator 14 (e.g., GPS data), output of the clock 80, status of the power source 84, or the like.

In selected embodiments, communications signals 26 may be received and processed by the same receiver 76 that receives and processes the signal 20 emitted from the beacons 12 in the system 10. Alternatively, a separate receiver may be included within each locator 14. This second receiver may include any suitable arrangement of one or more antennas, signal processor, controllers, and the like. Such receivers may optimize the time synchronization properties of the system 10. This may be done without significant increases in cost, as fewer locators 14 are needed within a system 10 when compared to higher volume, low-cost beacons 12.

A locator 14 in accordance with the present invention may include any suitable clock 80. The clock 80 may regulate the functions of the other subsystems 76, 78, 82, 84 of the locator 14. In selected embodiments, timestamps applied to the incident signal 22 may be derived from the clock 80 of a locator 14. Accordingly, if desired or necessary, such a clock may have a greater accuracy and stability than the clock 32 used within a beacon 12. Additionally, the clock 80 of a locator 14 may support synchronization. For example, upon receipt of an identified time interval of deviation, the clock 80 of a locator 14 may adjust accordingly.

In certain embodiments, a locator 14 may include a locator controller 82. Such a controller 82 may be responsible for coordinating the operation of the various subsystems 76, 78, 80, 84 of a locator 14. Additionally, a locator controller 82 may facilitate communication between the locator 14 and the server 16. In selected embodiments, a locator controller 82 may include a processor 106 operably connected to a memory device 108. Accordingly, the processor 106 may execute or operate on any programs or data stored by the memory device 108.

A locator controller 82 may also include a communication port 110. Such a port 110 may facilitate receipt and transmittal of information. For example, through the communication port 110, a locator 14 may transmit the processed signal 24 to the server 16. Additionally, if desired or necessary, a locator 14 may utilize the communication port 110 to receive synchronization information from the server 16. Alternatively, synchronization information may be provided to a locator 14 through some other mechanism. However, regardless of how synchronization information may be received, in selected embodiments, a locator controller 14 may ensure that time adjustments contained in the synchronization information may be properly applied.

A locator 14 in accordance with the present invention may include any suitable power source 84. The selection of a power source 84 may largely be determined by the operating characteristics of the locator 14 (e.g., voltage requirements, current requirements, mobility requirements, and the like). Other characteristics that may be considered when selecting a power source 84 may relate more directly to the power source 84 itself. Such characteristics may include cost, size, weight, reliability, duration, rechargability, and the like.

In selected embodiments, a power source 84 may comprise a battery, permitting the locator 14 to function without external power sources. Such embodiments may support a highly mobile system 10 capable of rapid deployment in remote areas (e.g., wilderness areas). In other embodiments, a power source 84 may simply comprise a connection connecting a locator 14 to some external power source related to its environment or host system (i.e., a vehicle, building, tower, or another equipment to which a locator 14 may secure). In still other embodiments, a power source 84 may comprise a battery providing power to the locator 14 only after the locator 14 has been separated from an external power source.

A locator 14 in accordance with the present invention may be embodied or included within any suitable form or structure. Such forms or structures may be selected according to requirements of the intended use. In selected embodiments, a locator 14 may be configured for permanent installation. For example, a locator 14 may be configured to secure to a tower (e.g., communications tower used for cellular telephone equipment), the roof of a building, or the like. In such an embodiments, the locator 14 may be weather hardened as desired or necessary.

In other embodiments, a locator 14 may be sized to provide sufficient mobility. For example, the locator 14 may be sized for deployment by vehicle (e.g., truck, ATV, helicopter, or the like). In still other embodiments, a locator may be sized for deployment by human power. For example, the locator 14 may be sufficiently small in size and light in weight to support transport in a backpack. Accordingly, a system 10 in accordance with the present invention may be constructed for long term collection of the desired information 28. Additionally, a system 10 in accordance with the present invention may be rapidly deployed to collect the desired information 28 in locations where the costs associated with more permanent locators 14 are not justified.

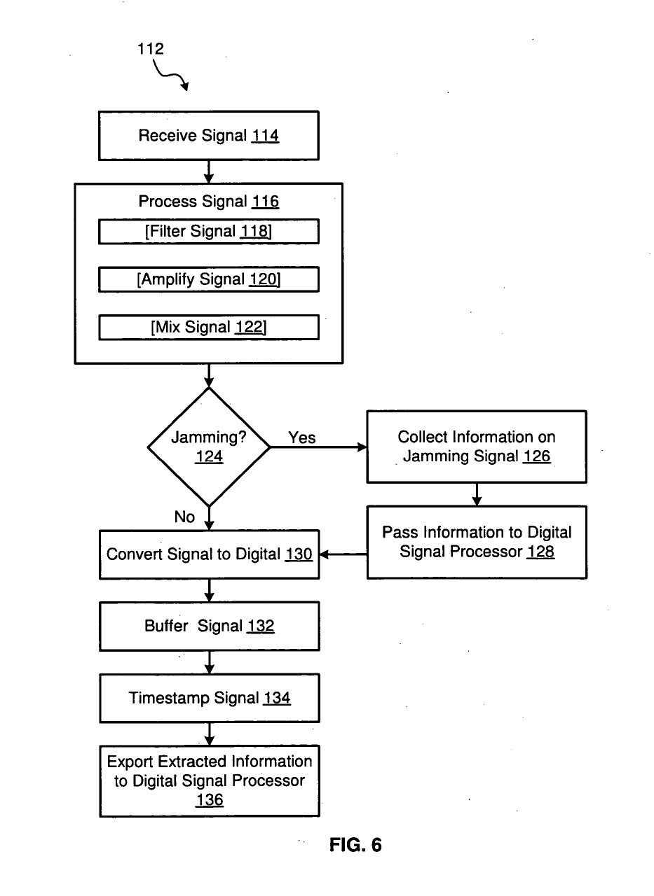

Referring to FIG. 6, in selected embodiments, a method 112 for operating a locator 14 in accordance with the present invention may begin upon receipt 114 of incident signal 22. The locator 14 may then process 116 the incident signal 22. In certain embodiments, processing 116 may include filtering 118 to remove out-of-band interference, amplification 120 to increase the signal or power level of certain signals, mixing 122 to frequencies facilitating additional processing, or performing any other operations or manipulations desired or necessary. Determinations regarding which operations or manipulations may be necessary may largely depend on the division of tasks between a locator 14 and a server 16. That is, the more processing 116 formed by the locator 14, the less that may need to be performed by the server 16, and vice versa.

The method 112 may continue with detection 124 of any jamming signals. If jamming signals are detected 124, a locator 14 may begin collecting 126 information corresponding thereto. For example, a locator 14 may collect information regarding the frequency of the jamming signal, the direction of origination of thejamming signal, and the like. This information may then be passed 128 to a digital signal processor to assist in mitigating the effects of the jamming signal.

Regardless of whether jamming signals are detected 124, the method 112 may continue by converting 130 the incident signal 22 from analog to digital. The resulting processed signal 24 may then be buffered 132 and timestamped 134 to reflect the time-of-arrival of the incident signal 22. Accordingly, the processed signal 24 may be passed 136 to a digital signal processor for additional processing.

A digital signal processor may be configured as part of a locator 14, server 16, or some combination of the two. For example, in selected embodiments, the processor 106 and memory device 108 forming the locator controller 82 may compromise all or part of a digital signal processor. Alternatively, all or part of the functionality of a digital signal processor may be incorporated within a server 16.

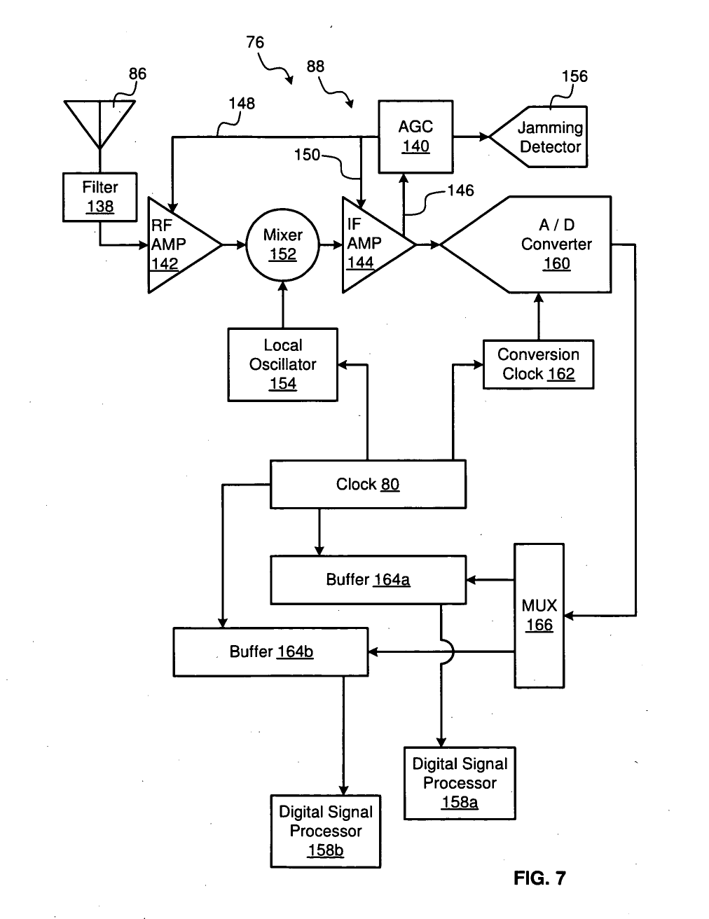

Referring to FIG. 7, a locator 14 in accordance with the present invention may receive and process short packets of a signal 20 (e.g., packets about one to two milliseconds in length). With appropriate duty cycle selection, such a signal 20 may be legally transmitted in L Band, Ultra High Frequency (UHF) bands, support high user count systems or networks, or the like. Such frequencies provide superior propagation characteristics for county-wide applications (i.e., superior propagation through windows, buildings, trees, and hills, with a reduction in undesirable multipath effects).

A locator 14 in accordance with the present invention may include hardware components, software components, or both. For example, in selected embodiments, a receiver 76 may largely be a software-based or digital receiver. In such embodiments, the incident signal 22 may be sampled at high speed and converted from analog to digital data. The signal 22 may then be processed by a digital signal processor (DSP). Accordingly, modifications to the receiver 76 may constitute changes to the software, while the hardware may remain substantially unchanged.

Without regard to which components are embodied as hardware and which are embodied as software, the front end of receiver 76 may contain various operation enhancing signal processors or circuits. For example, a receiver 76 may contain one or more filters 138 removing out-of-band interference. Such filters 138, together with an Automatic Gain Control 140 (AGC), may prevent out-of-band interference from saturating any amplifiers 142, 144 associated with the receiver 76. For example, in selected embodiments, circuits such as a Received Signal Strength Indicator 146 (RSSI) and AGC 140 may provide control voltages 148, 150 that logarithmically adjust the gains of a Radio Frequency amplifier 142 (RF AMP) and Intermediate Frequency amplifier 144 (IF AMP).

A mixer 152 may convert the carrier frequency of the incident signal 22 to an intermediate frequency better suited to the bandwidth and modulation of the signal 22. In selected embodiments, a mixer 152 may receive a signal from the RF AMP 142 and deliver the resultant signal of intermediate frequency to the IF AMP 144. A local oscillator 154 feeding the mixer 152 may be synthesized from a clock (e.g., clock 80 of the locator 14). Accordingly, the frequency conversion imposed by the mixer 152 may preserve carrier phase information, which may be used to refine timing and distance measurements, particularly at lower carrier frequencies.

In selected embodiments, a receiver 76 may include a jamming detector 156. A jamming detector 156 may detect unusually strong or narrowband signals. Information corresponding to such signals may be collected and passed to one or more digital signal processors 158. The digital signal processors 158 may then take appropriate action to mitigate any jamming effect, while extracting the desired signals.

Fast and accurate signal processing of short signal packets 64 is facilitated by an Analog-to-Digital Converter 160 (ADC) generating a digital representation of the incident signal 22. An ADC 160 in accordance with the present invention may be clocked at a rate permitting sufficient refinement in the timestamping process. In selected embodiments, the sampling rate of an ADC 160 may, for example, be as fast as twenty times (or greater) the chip rate (data rate) of any emitted signal packet 64. Accordingly, if necessary, a receiver 76 may include a conversion clock 162 imposing a multiplier on any clocking signal entering an ADC 160.

In selected embodiments, signal packets 64 emitted by various beacons 12 may arrive at a locator 14 at the same time. The probability of such collisions may increase with the number of beacons 12 operating within a particular system 10. Certain signal packets 64 may even be below the ambient noise floor and include no unspread preamble. The presence of such packets 64 may be difficult to detect without correlation.

In certain embodiments, to avoid missing any portion of a signal packet 64, offset, dual buffers 164a, 164b may be employed. Each buffer 164 may comprise a first-in-first-out (FIFO) memory system. The length (storage capacity) of each buffer 164 may be sufficient to store at least two signal packets 64 (i.e., at least two times the duration 62 of the transmit interval). In selected embodiments, the storage capacity of each buffer 164 may be just over two signal packets 64.

The buffers 164 may also be offset from one another by at least the length of a signal packet. That is, the buffers 164 may store respective copies of the digital representation generated from the incident signal 22. However, the copy stored by one buffer 164a may be offset in time from the copy stored in the other buffer 164b. This offset may be at least the length (time) of a signal packet 64. In selected embodiments, this offset is just over one signal packet 64.

Accordingly, any given signal packet 64 emitted by a beacon 12 will be contained entirely within at least one of the buffers 164. In selected embodiments, a receiver 76 may include a multiplexer 166 (MUX) appropriate for copying the digital representation of the incident signal 22 to both buffers 164 to generate the offset.

In operation, at a certain start time a gross timestamp may be applied to the start of one buffer 164a. At some later time a gross timestamp may be applied to the start of the other buffer 164b. After each buffer 164a, 164b is loaded to capacity, the content may be passed to a corresponding digital signal processor 158a, 158b. The digital signal processors 158 may perform block and parallel processing with gross correlation to every known active pseudo noise code in the system 10. Gross correlation may involve periodic correlation (e.g., correlation to every fifth or tenth sample) until a signal packet 64 is detected. Once detected, all the sample points corresponding to a particular signal packet 64 may be used to fine tune the correlation to the edges and carrier phase of the contained signal 20.

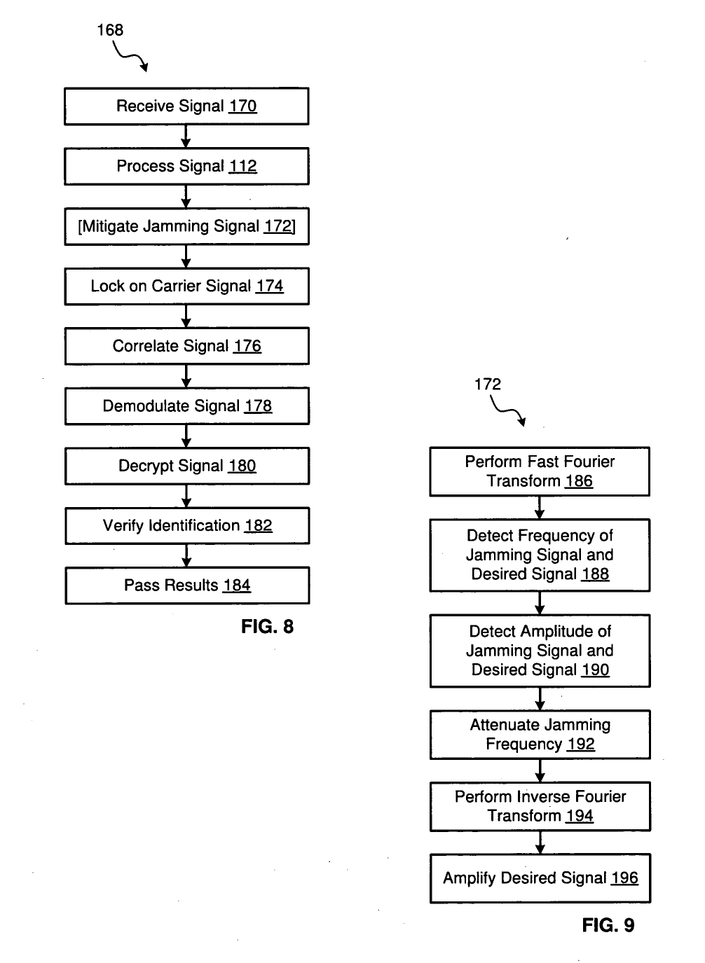

Referring to FIG. 8, in general, the steps performed by a digital signal processor 158 may be divided into two main groups. The first group of steps may be directed toward determining the times of arrival of the various signal packets 64 emitted by various beacons 12. These times of arrival may be used (e.g., by a server 16) to determine the locations of the various beacons 12. The second group of steps may be directed toward determining what information is encoded within the various signal packets 64. The order in which these different groups of steps are carried out may vary from embodiment to embodiment. In selected embodiments, the first group of steps may largely precede the second group of steps.

For example, in certain embodiments, a method 168 of operation for a digital signal processor 158 in accordance with the present invention may begin with receipt 170 of a packet or quantity of an incident signal 22 covering a selected period of time. In selected embodiments, the size of the packet may correspond to the capacity of the buffer 164 delivering the packet. That is, once a buffer 164 is filled to capacity, that packet of the incident signal 22 may be passed to a digital signal processor 158.

Once received 170, jamming signals contained within the packet of the incident signal 22 may be mitigated 172. Such mitigation 172 may attempt to isolate and remove the jamming signals, while leaving the desired signals 20 (signal packets 64) intact.

The process 168 may continue by locking 174 a local oscillator operating at the Intermediate Frequency to the frequency and phase of the signal 20 emitted by one or more beacon 12. With the carrier frequency of the beacon signal 20 synchronized to the chip rate of the code generator 49, such locking 174 may support correlation 176 to recover more precisely the pseudo noise code sequence and timing of reception (i.e., timestamp) of the various signal packets 64 relative to the clock 80 of the locator 14.

In selected embodiments, variations in timing of transmissions of beacon signals 20 may be mathematically related to the pseudo noise portions of the signal packets 64. These variations in timing may be known to both the beacons 12 and the locators 14. Accordingly, in such embodiments, a digital signal processor 158 may know when to look for the signal packet 64 of any given beacon 12.

Various techniques using modulation and coded preambles may be used to facilitate a determination of when a signal packet 64 is received by a locator 14. In selected embodiments, coded preambles may provide distinct, recognizable patterns for which a locator may search the packet incident signal 22. Such methods may permit rapid carrier lock 174. Following carrier lock 174 and course correlation, the preamble bit rate or code rate may be increased briefly to permit detection of the timing edges of the signal packet 64. This may permit a timestamp to be applied (i.e., correlation 176) with sufficient time accuracy (e.g., within fifty nanoseconds or better) to provide the desired resolution of location for the beacons 12 within the system 10.

After determining the time of arrival for each signal packet 64 contained with the packet of the incident signal 22, a digital signal processor 158 may demodulate 178 the signal packets 64. Such demodulation 178 may extract the encoded information from signal packets 64.

In systems 10 using Direct Spread Spread Spectrum (DSSS), the data rate may be much lower than the chip or spreading rate to provide processing gain and jamming margin. This may facilitate modulation using Code Division Multiple Access (CDMA). That is, the processing gain permits enhancement of signals with a specific code while rejecting or correlating out other signals with other mutually orthogonal codes, jamming signals, or noise. For example, for a spreading bandwidth of one megahertz and a data rate of fifty kilohertz, the processing gain may be twenty or thirteen decibels.

Alternate modulation techniques that do not include CDMA may use other methods to find similar results. For example, other modulation techniques may require a much narrower transmission bandwidth for the data, transmit simultaneously on multiple carriers, increase data rate and retransmit the encrypted date multiple times, or increase data rate but shorten transmission time. Each of these alternatives may decrease the probability of concurrent transmissions from multiple beacons 12.

At a data rate of fifty kilobytes per second, a signal one millisecond in length may provide up to fifty bits of identification codes 72 or other data 74. Carrier locking 174 and correlation 176 may facilitate demodulation to recover this encoded information 72, 74. If desired or necessary, a Cyclic Redundancy Check (CRC) error check or a Forward Error Correction (FEC) algorithm may be applied to detect or correct transmission data errors.

In selected embodiments, the information 72, 74 encoded within a signal packet 64 may be encrypted. Accordingly, if necessary, a digital signal processor 158 may then decrypt 180 the information to provide a useable result.

Encryption and decryption in accordance with the present invention may follow any variety of sophisticated symmetrical or asymmetrical techniques. For example, in selected embodiments, the encryption and decryption codes may change with transmission or packet sequence using exclusive-or, shift, or non-repeating algorithms Public and private key techniques (e.g., RSA, Secure Sockets Layer (SSL)) may be used because a beacon 12 may start and perform the simpler encrypting process at known starting points. For example, a beacon 12 may use an ID code 72 as the seed and start the decrypting counter at a value known to the system 10. Moreover, the locators 14 and server 16 share enough processing power to find the starting place of a non-repeating sequence of keys used in every transmission, the secure algorithm being known only to the system 10. Accordingly, a beacon 12 in accordance with the present invention does not require a highly sophisticated logic array or processor to encrypt fifty to sixty bits of data.

Once a packet 64 is decrypted 180, a digital signal processor 158 may verify 182 the identification of the beacon 12 from which the packet 64 was emitted. In selected embodiments, this verification 182 may comprise comparing the identifier extracted from the signal packet 64 to a list of beacons 12 corresponding to the particular system 10. If the source beacon 12 does not correspond to the system 10, the signal packet 64 may be ignored. Otherwise, the identification information corresponding to the signal packet 64 may be logically secured to the derived time of arrival and any other information encoded within the signal packet 64. This combination of data may then be passed 184 (e.g., to a server 16) for further processing.

Referring to FIG. 9, jamming signals received by a locator 14 may be mitigated in any suitable manner. For example, a Received Signal Strength Indicator 146 (RSSI) may be used by a server 16 to determine the distance between each locator 14 and the jamming source. These distances may be used to determine an approximate location of a jamming source. Personnel may then be dispatched to the approximate location to deactivate the jamming source.

In selected applications or environments, such a mitigation strategy may be more effective than in others. For example, multipath reflections and other terrain propagation problems that are also a function of frequency may negatively affect the apparent RSSI. Accordingly, the approximate location determined for the jamming source may be excessively inaccurate.

In certain embodiments, the antenna 86 of a receiver 76 may comprise a multi-element array connected to a phase and signal level processor. Such an arrangement may directionally nullify a certain amount (typically thirty decibels) of jamming signal. This may be done while retaining normal gain in other directions where beacons 12 included within the system 110 may be located. Additionally, such an arrangement may determine the direction from which the locator 14 is receiving the jamming signal. This direction information may be relayed to a server 16. Accordingly, personnel may be dispatched in that direction to deactivate the jamming source.

Further, as stated hereinabove, a digital signal processor 158 may mitigate 172 jamming signals. This mitigation 172 may be accomplished in any suitable manner. For example, in selected embodiments, mitigation by a digital signal processor 158 may begin by performing 186 a Fast Fourier Transform (FFT) on any incident signal 22 that is jammed.

A FFT may comprise any algorithm that may be used to determine the power versus frequency graph for the incident signal 22. Typically, the frequencies having the greatest power are those corresponding to the jamming signals. Accordingly, the digital signal processor 158 may detect 188 the frequency of the jamming signals, detect 190 the amplitude of the jamming signals, and then intelligently attenuate 192 the jamming frequencies.

The mitigation 172 may continue by performing 194 an Inverse Fourier Transform (IFT) to recover the incident signal 22 from its Fourier Transform. If desired or necessary, the resulting portions of the incident signal 22 may then be amplified 196. This process 172 for mitigating jamming signals may be particularly effective at rejecting Continuous Wave (CW) jamming signals using Direct Spread Spread Spectrum (DSSS).

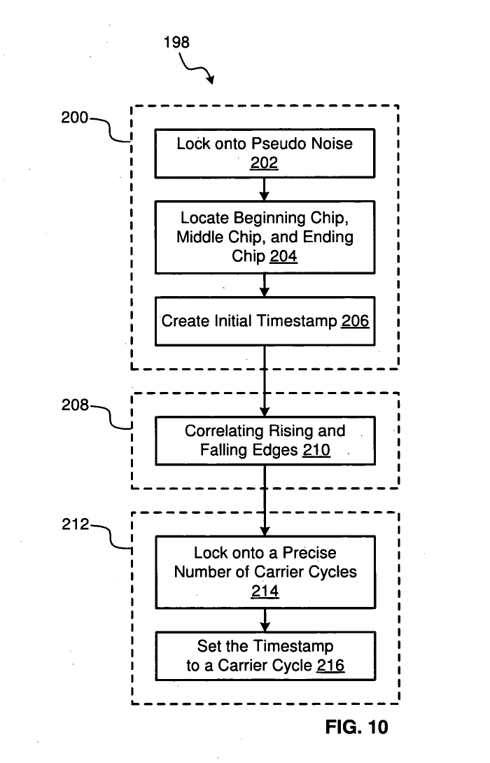

Referring to FIG. 10, in selected embodiments in accordance with the present invention, carrier wave locking 174 and correlation 176 (collectively forming the process 198 for timestamp resolution) may occur in several stages of increasing resolution. For example, in a first stage 200, the digital signal processor 158 may lock 202 onto the pseudo noise (PN) code sequence of a signal packet 64. This code sequence may be many chips long (e.g., over one thousand chips).

Each such chip may be defined as the length of time required to transmit either a zero or a one in a binary pulse code. Accordingly, no significant repetition of the code sequence need occur during a one to two millisecond transmission. As a result, through correlation 176, the beginning chip, middle chip, and ending chip of the code sequence may be located 204. This may allow an initial timestamp to be created 206. This initial timestamp may have a resolution of one chip (e.g., a resolution of one microsecond for a one microchip per second code rate, a resolution of one hundred nanosecond for a ten megachips per second code rate, or the like).

In a second stage 208, the timestamp resolution may be more finely resolved by correlating 210 the rising and falling edges of the code sequence. In selected embodiments, this may be accomplished by shifting a clock assigned to the correlation process 176 in small increments (e.g., in one-tenth or one-twentieth chip increments), averaged over the entire code sequence.

In a third stage 212, the hardware or software providing locking 174 on the carrier wave may permit locking 214 onto a precise number of carrier cycles from the beginning edge of each chip edge. Accordingly, a timestamp may be set 216 for each carrier cycle time period. For example, for a carrier frequency of three hundred thirty-three megahertz, the carrier cycle period would be three nanoseconds, corresponding to a distance resolution of three feet.

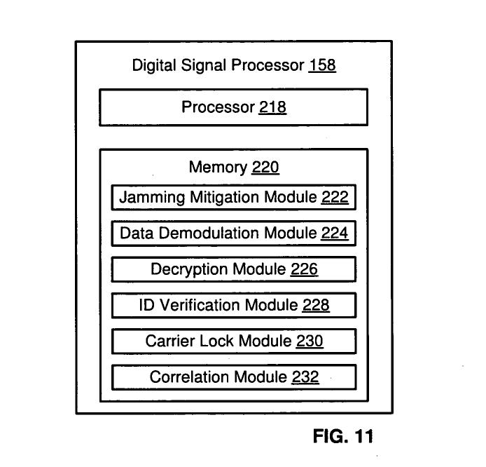

Referring to FIG. 11, a digital signal processor 158 in accordance with the present invention may be embodied as hardware, software, or some combination of hardware and software. In selected embodiments, one or more digital signal processors 158 may be contained within a locator 14. In other embodiments, one or more digital signal processors 158 may be contained within a server 16. In still other embodiments, the various functions of one or more digital signal processors 158 may be divided between a locator 14 and a server 16.

In selected embodiments, a digital signal processor 158 may include a processor 218 operably connected to a memory device 220. Depending on the particular application, this processor 218 and memory device 220 may be the processor 106 and memory device 108 forming the locator controller 82. Alternatively, this processor 218 and memory device 220 of a digital signal processor 158 may be the same as those forming the server 16. However, if desired or necessary, the processor 218 and memory device 220 of a digital signal processor 158 may be separate and independent.

In selected embodiments, a memory device 220 may store data structures executable by the processor 218. In certain embodiments, these data structures may include a jamming mitigation module 222. A jamming mitigation module 222 may operate on a digital representation of the incident signal 22 to extract or mitigate components thereof corresponding to a jamming signal. For example, a jamming mitigation module 222 may implement the jamming signal mitigation process 172 discussed hereinabove.

In certain embodiments, the data structures stored within a memory device 220 may include a data demodulation module 224. This module 224 may extract the encoded information from the carrier waves of the various signal packets 64. In selected embodiments, this information may be encrypted. Accordingly, in selected embodiments, a digital signal processor 158 may include a decryption module 226 to decrypt the information to provide a useable result.

Once decrypted, an identification verification module 228 may determine which beacon 12 emitted the signal 20. In selected embodiments, an identification module 228 may also logically secure the beacon identification to the other extract information and the appropriate timestamp. Accordingly, the information may be passed 184 as a unit for further processing.

In selected embodiments, a digital signal processor 164 may include a carrier lock module 180. A carrier lock module 180 may perform any locking 174, 202, 214 needed. Accordingly, a carrier lock module 40 may support correlation to recover more precisely the pseudo noise code sequence and timing of reception (i.e., timestamp) of the signal 20 relative to the clock 80 of the locator 14. By so doing, a carrier lock module 180 may compensate for the inaccuracies or asynchronous nature of a clock 32 within the particular beacon 12 emitting the signal 20.

A digital signal processor 158 in accordance with the present invention may also include a correlation module 182. A correlation module 182 may perform any correlating 176, 210 needed. Accordingly, using the gross timestamp applied to the particular packet or segment of an incident signal 22 as it begins filling the buffer 164, the carrier lock module 180 and the correlation module 182 may cooperate to determine the time at which the particular locator 14 received a particular signal packet 64.

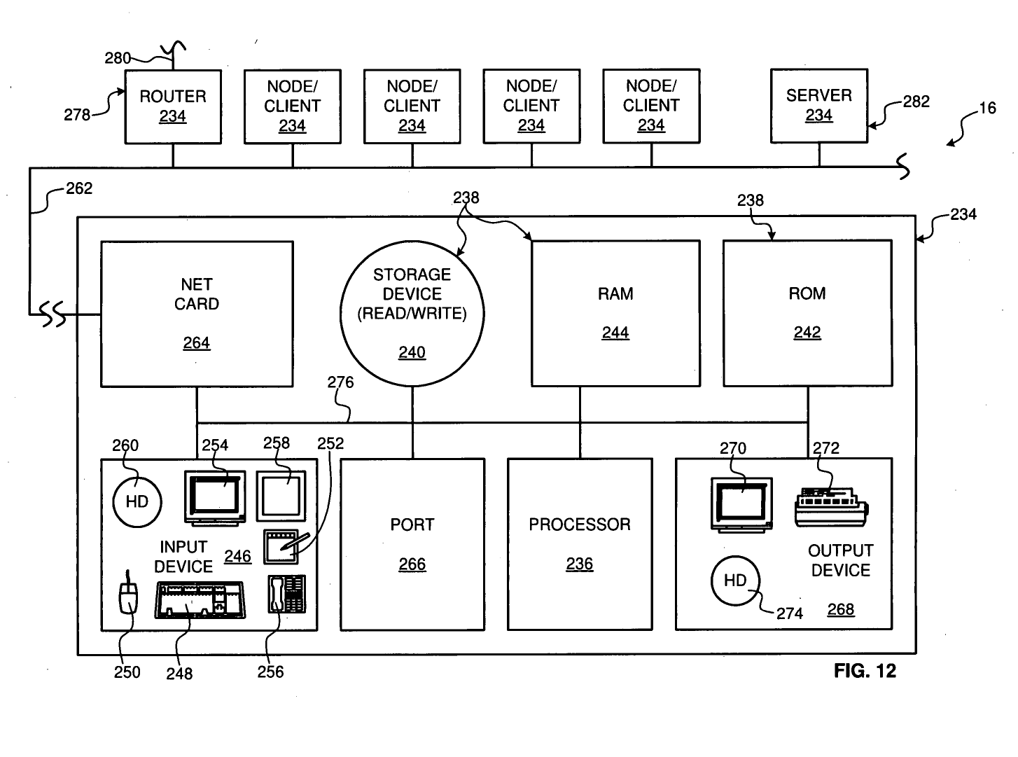

Referring to FIG. 12, a server 16 in accordance with the present invention may include one or more nodes 234 (e.g., client 234, computer 234). Such nodes 234 may contain a processor 236 or CPU 236. The CPU 236 may be operably connected to a memory device 238. A memory device 238 may include one or more devices such as a hard drive 240 or other non-volatile storage device 240, a read-only memory 242 (ROM 242), and a random access (and usually volatile) memory 244 (RAM 244 or operational memory 244). Such components 236, 238, 240, 242, 244 may exist in a single node 234 or may exist in multiple nodes 234 remote from one another.

In selected embodiments, a server 16 may include an input device 246 for receiving inputs from a user or from another device. Input devices 246 may include one or more physical embodiments. For example, a keyboard 248 may be used for interaction with the user, as may a mouse 250 or stylus pad 252. A touch screen 254, a telephone 256, or simply a telecommunications line 256, may be used for communication with other devices, with a user, or the like. Similarly, a scanner 258 may be used to receive graphical inputs, which may or may not be translated to other formats. A hard drive 260 or other memory device 260 may be used as an input device whether resident within the particular node 234 or some other node 234 connected by a network 262. In selected embodiments, a network card 264 (interface card) or port 264 may be provided within a node 234 to facilitate communication through such a network 262.

In certain embodiments, an output device 268 may be provided within a node 234, or accessible within the server 16. Output devices 268 may include one or more physical hardware units. For example, in general, a port 266 may be used to accept inputs into and send outputs from the node 234. Nevertheless, a monitor 270 may provide outputs to a user for feedback during a process, or for assisting two-way communication between the processor 236 and a user. A printer 272, a hard drive 274, or other device may be used for outputting information as output devices 268.

Internally, a bus 276, or plurality of buses 276, may operably interconnect the processor 236, memory devices 238, input devices 246, output devices 268, network card 264, and port 266. The bus 276 may be thought of as a data carrier. As such, the bus 276 may be embodied in numerous configurations. Wire, fiber optic line, wireless electromagnetic communications by visible light, infrared, and radio frequencies may likewise be implemented as appropriate for the bus 276 and the network 262.

In general, a network 262 to which a node 234 connects may, in turn, be connected through a router 278 to another network 280. In general, nodes 234 may be on the same network 262, adjoining networks (i.e., network 262 and neighboring network 280), or may be separated by multiple routers 278 and multiple networks as individual nodes 234 on an internetwork. The individual nodes 234 may have various communication capabilities. In certain embodiments, a minimum of logical capability may be available in any node 234. For example, each node 234 may contain a processor 236 with more or less of the other components described hereinabove.

A network 262 may include one or more network servers 282. Network servers 282 may be used to manage, store, communicate, transfer, access, update, and the like, any practical number of files, databases, or the like for other nodes 234 on a network 262. Typically, a network server 282 may be accessed by all nodes 234 on a network 262. Nevertheless, other special functions, including communications, applications, directory services, and the like, may be implemented by an individual network server 282 or multiple network servers 282.

In general, a node 234 may need to communicate over a network 262 with a network server 282, a router 278, or other nodes 234. Similarly, a node 234 may need to communicate over another neighboring network 280 in an internetwork connection with some remote node 234. Likewise, individual components may need to communicate data with one another. A communication link may exist, in general, between any pair of devices.

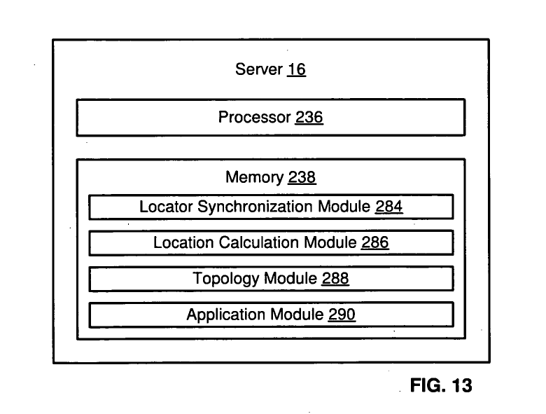

Referring to FIG. 13, in selected embodiments, a server 16 in accordance with the present invention may include a memory device 238 storing data structures executable by the processor 236. In certain embodiments, these data structures may include attendant error checking software tolerant to the error probabilities and specification of the system 10.

Additionally, the data structures stored within a memory device 238 may include a locator synchronization module 284. A locator synchronization module 284 may be responsible for periodically synchronizing the clocks 80 of the various locators 14. Such synchronization may be accomplished in any suitable manner. For example, in selected embodiments, a locator synchronization module 284 may synchronize the clocks 80 of the various locators 14 using multi-order clock correction.

In certain embodiments, the data structures stored within a memory device 138 may also include a location calculation module 284. A location calculation module 284 may receive the timestamp information corresponding to one or more beacons 12 from at least three locators 14 and calculate the position of the one or more beacons 12.

In systems 10 using more than three locators 14, the probability is high that more than three of the locators 14 will receive valid signals 20 from a single beacon 12. Accordingly, a location calculation module 284 in accordance with the present invention may select the most reliable locators 14 to calculate the location of that beacon 12. For example, it may be probable that the locators 14 nearest the beacon 12 may receive the best, strongest, and most easily identified signal 20.

In certain situations, less than three locators 14 may fully identify the signal packet 64 from a particular beacon 12. In such situations, a location calculation module 284 may disqualify that particular beacon 12 and drop it from the calculation matrix. The criteria for determining when to drop the report of a locator 14 may vary depending on the system 10 and its specifications for accuracy and reliability. Thus, a server 16 may include attendant error-checking software that is tolerant of the error probabilities and may excuse dropping or missing several reports in a given time period. When the reports produced by a particular locator 14 consistently fail to agree with those produced by other locators 14, more involved maintenance of that locator 14 may be scheduled.

In selected situations, more than three locators 14 may report highly reliable information. In such situations, a location calculation module 284 in accordance with the present invention may use the information provided by the additional locators 14 to improve the accuracy and reliability of the location calculation.

If desired, once the location of a particular beacon 12 is determined, that location may be communicated to a user (e.g., operator, client 18) via an output device 268. For example, the location of a beacon 12 may be depicted on the screen of a monitor 270 as it relates to other beacons 12, landmarks, or the like. To perform this function, in selected embodiments, a server 16 may include a topology module 288.

A topology module 288 may provide the background upon which the location of one or more beacons 12, locators 14, or the like may be superimposed. A topology module 288 may also position icons (e.g., dots) indicating the locations of the one or more beacons 12, locators 14, or the like with respect to the background. In general, the background produced by a topology module 288 may comprise any useful representation of the area covered by the system 10. For example, in selected embodiments, a topology module 288 may generate a city map. In other embodiments, a topology module 288 may generate a topographical map showing various landmarks such as geological formations, bodies of water, man-made structures, or the like.

In selected embodiments, a server 16 may include an application module 290. An application module 290 may organize the information collected and calculated by a system 10 in accordance with the present invention. In certain embodiments, an application module 290 may control which clients 18 receive which information. Additionally, in some embodiments, an application module 290 may support manipulation of the information or additional computations based on the information.

For example, an application module 290 may determine the distance between a beacon 12 and some other object (e.g., beacon 12, landmark, boundary, or the like). Accordingly, an application module 290 may send a communication (e.g., alarm) to a client 18 when a particular beacon 12 crosses a boundary, comes within a certain distance of another beacon 12, passes beyond a certain distance from a particular landmark, travels at a rate of speed above a particular threshold, or the like.

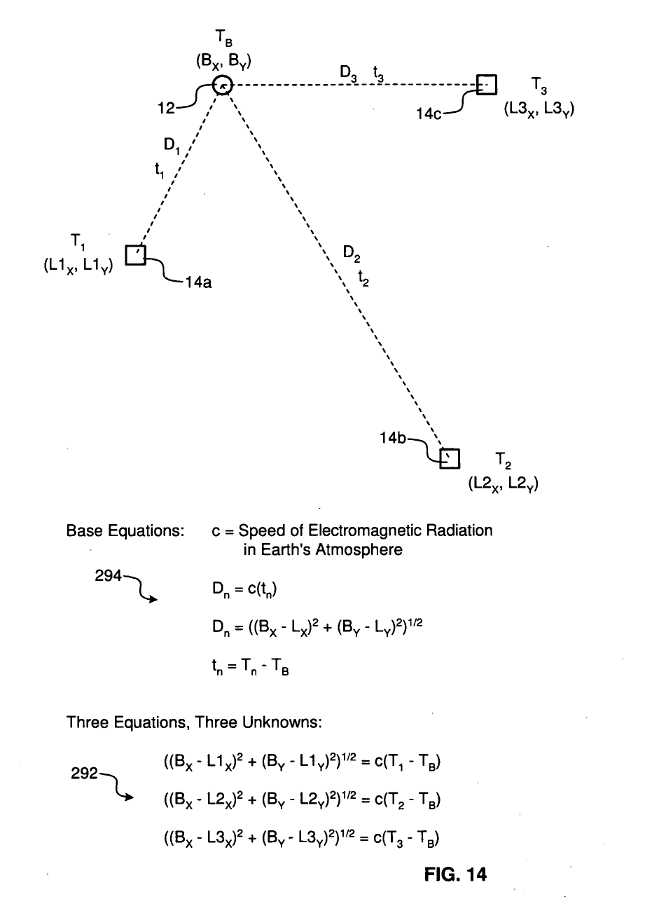

Referring to FIG. 14, a server 16 (e.g., location calculation module 286 within a server 16) may calculate the location of a beacon 12 in any suitable manner. In selected embodiments, a server 16 in accordance with the present invention may calculate the location of a beacon 12 without knowing beforehand the actual time a signal packet 64 was emitted from that beacon 12. In certain embodiments, this may be done in two dimensions using three equations 292 to find three unknowns.

The three equations 292 may be derived from certain base equations 294. In selected embodiments, these base equations 294 may include expressions equating distance to velocity multiplied by time, distance to the square root of the sum of the squares of the Cartesian distances (i.e., the Pythagorean Theorem), and time of travel to the difference between the time when a beacon 12 emits a signal packet 64 and the time a locator 14 receives that signal packet 64.

In calculating the location of a beacon 12, the propagation velocity of a signal packet 64 emitted by that beacon 12 may be assumed to be a known quantity (i.e., approximately one foot per nanosecond). Of course, propagation velocity of electromagnetic radiation may vary according to the density of the air and the ground effects. Accordingly, in selected embodiments, while synchronizing the clocks 80 of the locators 14, which are separated by known distances, a server 16 may collect information regarding actual propagation velocities. The server 16 may then use the information to fine tune any assumptions regarding propagation velocity.

Over short distances (e.g., ten to twenty kilometers), variations in propagation velocity are relatively small in comparison to multipath effects. Multipath effects are caused when waves reflect off buildings, hills, the ground, or the like. Such effects are generally undesirable. Accordingly, systems 10 in accordance with the present invention may actively reduce multipath effects. For example, the antenna 86 of a locator 14 may be mounted on a tower. By distancing the antenna 86 from the ground, certain local multipath effects may be reduced. Additionally, or in the alternative, digital signal processors 158 in accordance with the present invention may utilize multipath rejection processing.

Accordingly, once the three equations 292 are assembled the “knowns” may include the propagation velocity, the two-dimensional coordinates of each of three locators 14, and the times when each of the three locators 14 received the signal packet 64. In general, the coordinates of each of three locators 14 may indicate the phase center of the antenna 86 of the receiver 76 of the respective locator 14. The coordinates may be based on any suitable system in one, two, or three dimensions. For example, coordinates may be geographic, mapping, surveying, Cartesian, polar, or rectangular systems.

The coordinates of a locator 14 may be determined in any suitable manner. In selected embodiments, a GPS unit incorporated within a locator 14 may report the position of the antenna 86. In some embodiments, the locators 14 within a system 10 may be used to determine the locations of newly positioned locators 14. For example, a beacon 12 may be placed near the antenna 86 of a new locator 14. Accordingly, when the system 10 determines the location of that beacon 12, it is effectively determining the location of the new locator 14. Alternatively, signals emitted by the transmitter 78 of a locator 14 may be used by the other locators 14 to determine the location thereof. In other embodiments, the actual coordinates of a locator 14 may be determined by survey. In still other embodiments, a locator 14 may be placed on a tower or building, the coordinates of which have already been determined.

In certain embodiments, a server 16 may correct or adjust the location information provided by a locator 14. For example, a GPS unit located within a locator 14 may report a certain position. However, the antenna 86 of the locator 14 may actually be spaced some distance from the GPS unit. If this spacing is known and substantially constant, the server 16 may correct the position information for that locator 14 accordingly. Such corrections and adjustments may improved the accuracy of the location determinations produced by a system 10 in accordance with the present invention.

Additionally, in selected embodiments, a locator 14 may be divided into several sections. For example, an antenna 86 may be located on a tower, while the rest of the receiver 76 may be located on the ground in a controlled environment. In such embodiments, care may be taken to accommodate any time delay induced as a signal is communicated from the antenna 86 to the rest of the receiver 76. This delay may be accommodated through calibration of the various locators 14. Alternatively, any delay in processing or communication of signals 20 may be taken into account by a server 16 during its determinations of location.

In selected embodiments, the unknowns within the three equations 292 may include the coordinate of the beacon 12 in each of the two dimensions and the time when that beacon 12 actually emitted the signal packet 64. Accordingly, once the “knowns” are entered, a server 16 may simultaneously solve the three equations 292 to determine the coordinates of the beacon 12. A similar process may be followed to determine the location of all beacons 12 within the system 10.

While the server 16 may also determine the time at which the beacon 12 emitted the signal packet 64, that information is usually of little value. However, by treating the time of emission as an unknown, a server 16 need not rely on a report from the beacon 12 indicating the time the signal packet 64 was sent. Thus, the clock 32 within the beacon 12 need not be synchronized to any other component within the system 10.

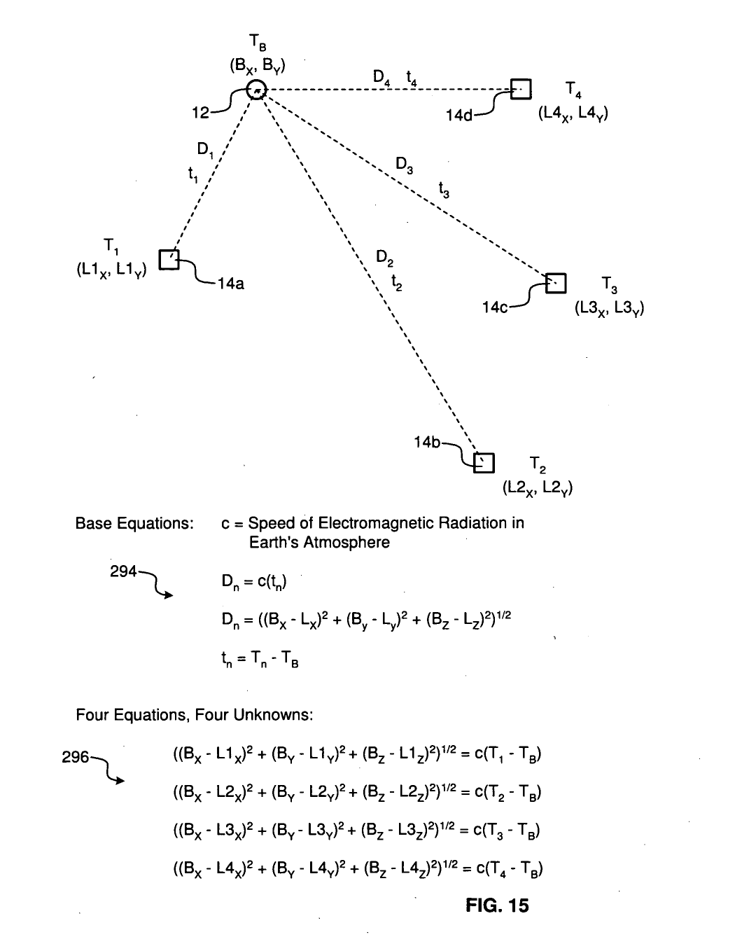

Referring to FIG. 15, in certain situations, it may be desirable to determine the location of a beacon 12 in a three-dimensional space. Similar to a two-dimensional location determination, a three-dimensional location determination may be made without knowing beforehand the actual time a signal packet 64 was emitted from that beacon 12.

In certain embodiments, a three-dimensional location determination may be done using four equations 296 to find four unknowns. Accordingly, a system 10 equipped to determine location in three-dimensional space may include at least four locators 14. To improve the accuracy of such determinations, one of the four locations 14 may be positioned at an elevation of at least the possible height that may be obtained by a beacon 12 within the system 10.

As with the two-dimensional calculation described with respect to FIG. 14, the four equations 296 may be derived from certain base equations 294. Once the four equations 296 are assembled the “knowns” may include the propagation velocity, the three-dimensional coordinates of each of four locators 14, and the times when each of the four locators 14 received the signal packet 64.

The unknowns within the four equations 296 may include the coordinate of the beacon 12 in each of the three dimensions and the time when that beacon 12 actually emitted the signal packet 64. Accordingly, once the “knowns” are entered, a server 16 may simultaneously solve the four equations 296 to determine the three-dimensional coordinates of the beacon 12. Again, a similar process may be followed to determine the location of all beacons 12 within the system 10.

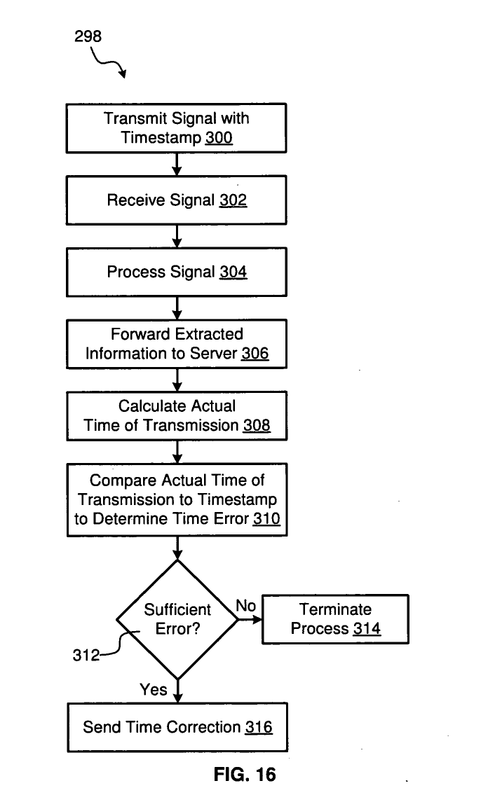

Referring to FIG. 16, the clocks 80 within the various locators 14 of a system 10 may be synchronized in any suitable manner. In selected embodiments, a first method 298 of synchronization may begin when a locator 14 transmits 300 a communication signal 26. This signal 26 may include a timestamp indicating the time of transmission 300, as determined by the clock 80 of the transmitting locator 14. This signal 26 may be received 302 by at least three other locators 14 (receiving locators 14).

The receiving locators 14 may process 304 the signal 26 in a manner similar to how they would process 112 the signal 20 of a beacon 12. Accordingly, they each may determine an appropriate time of receipt (timestamp) for the signal 26 and forward 306 it to the server 16.

Just as it may with a beacon 12, a server 16 may use the information provided by the receiving locators 14 to calculate 308 the location and actual time of transmission for the transmitting locator 14. This actual time may be compared 310 to the time of transmission encoded by the transmitting locator 14 within the signal 26.

The server 16 may then determine 312 if there is a sufficient error to merit correction. If not, the synchronization process 298 may terminate 314. Otherwise, the server 16 may send 316 a time correction or adjustment to the transmitting locator 14 for implementation. This process 298 may be followed until all new or deviant locators 14 have been synchronized with the receiving locators 14.

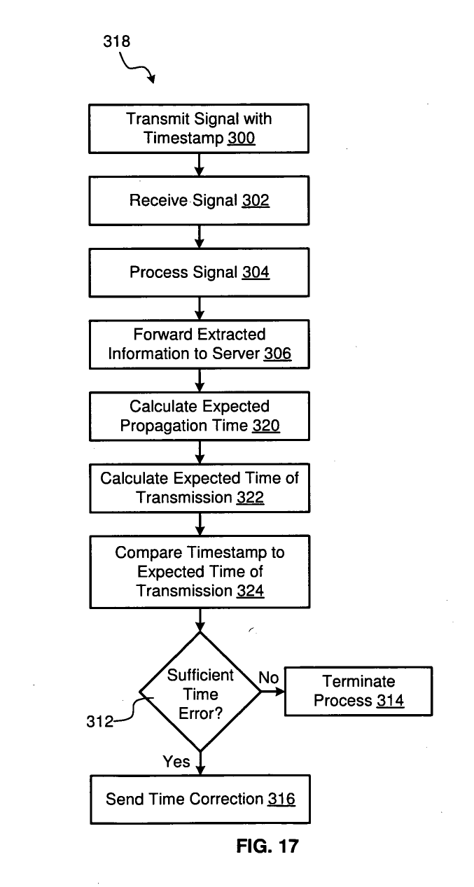

Referring to FIG. 17, in selected embodiments, a second method 318 of synchronization may also begin when a locator 14 transmits 300 a communication signal 26. Again, the signal 26 may include a timestamp indicating the time of transmission 300, as determined by the clock 80 of the transmitting locator 14. This signal 26 may, however, be received 302 by a base locator 14. In selected embodiments, the base locator 14 may be centrally located. Accordingly, if desired, all of the various locators 14 within the system 10 may synchronize with the base locator 14.

After receipt 302, the base locator 14 may process 304 the signal 26 in a manner similar to how it would process 112 the signal 20 of a beacon 12. Accordingly, the base locator 14 may determine an appropriate time of receipt (timestamp) for the signal 26. The base locator 14 may then forward 306 the extracted information to the server 16.

A server 16 may receive the information from the base locator 14. Based on the known distance between the transmitting and base locators 14, the server 16 may calculate 320 the expected propagation time of a signal 26 traveling from the transmitting locator 14 to the base locator 14. The server 16 may then use this expected propagation time in combination with the timestamp applied to the signal 26 by the base locator 14 to calculate 322 an expected time of transmission. This expected time of transmission may be compared 324 to the actual time of transmission encoded by the transmitting locator 14 within the signal 26.

The server 16 may then determine 312 if there is a sufficient error to merit correction. If not, the synchronization process 318 may terminate 314. Otherwise, the server 16 may send 316 a time correction or adjustment to the transmitting locator 14 for implementation. This process 318 may be followed until a desired number of locators 14 (e.g., all) are synchronized with the base locator 14.

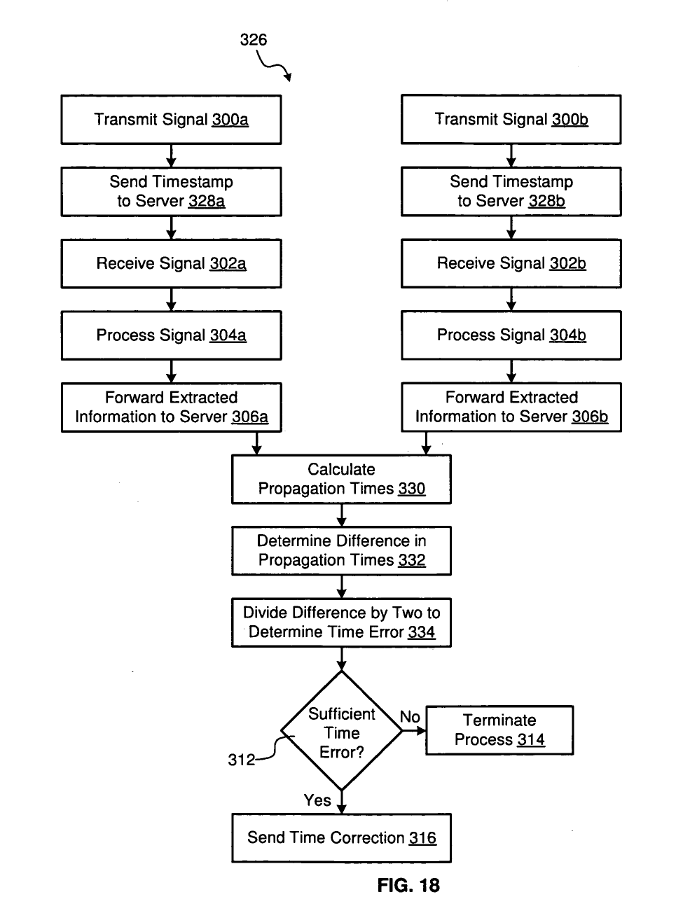

Referring to FIG. 18, in certain embodiments, a third synchronization method 326 may begin when a base locator 14 transmits 300a a communication signal 26. Once the signal 26 is sent, the base locator 14 may send 328a the timestamp (i.e., time of transmission) for that signal 26 to the server 16. Similarly, some other, non-base locator 14 may transmit 300b a communication signal 26. Afterward, this non-base locator 14 may also send 328b the timestamp (i.e., time of transmission) for that signal 26 to the server 16. Thus, the base and non-base locators 14 may exchange signals 26.

Upon receipt 302a, 302b of the corresponding signal 26 of the other, the base and non-base locators 14 may process 304a, 304b the signal 26. Each locator 14 may process 304a, 304b the signal 26 in a manner similar to how it would process 112 the signal 20 of a beacon 12. Any extracted information may then be forward 306a, 360b to the sever 16.

At the server 16, the apparent propagation times for the signals 26 may be calculated 330. In selected embodiments, the propagation time may be calculated 330 by finding the difference between the timestamp sent 328a, 328b to the server 16 and the corresponding timestamp determined by the other or opposing locator 14. The server 16 may then determine 332 the difference in propagation times. This difference may be divided 334 by two, as it represents a double counting of any deviation in time between the base locator 14 and the non-base locator 14.

The server 16 may then determine 312 if there is a sufficient error to merit correction. If not, the synchronization process 318 may terminate 314. Otherwise, the server 16 may send 316 a time correction or adjustment to the non-base locator 14 for implementation. This process 318 may be followed until a desired number of locators 14 (e.g., all) are synchronized with the base locator 14.

In selected embodiments, the command to initiate a synchronization process 298, 318, 326 may originate from the server 16. The server 16 may initiate such processes according to operator input, input from clients 18, preprogrammed schedules, or some combination thereof. In other embodiments, the locators 14 may each initiate a synchronization process according to their own programming. Accordingly, in either arrangement, the locators 14 may be synchronized at whatever interval is necessary to maintain a desired accuracy, considering the accuracy of the clocks 80 of the locators 14 collectively or individually.

A system 10 in accordance with the present invention may be used in any desired manner. All such methods of use are included within the scope of the present invention. It will be readily understood that the methods of use included with the present invention may be arranged and designed in a wide variety of configurations. Thus, the following more detailed descriptions of selected methods of use are not intended to limit the scope of the invention, but are merely representative of various methods of use included within the present invention.

### 1. EXAMPLE I

In one selected embodiment, Applicants believe a system 10 in accordance with the present invention may be used by law enforcement to regulate and enforce protective orders (restraining orders).

Currently, a judicial authority may issue a protective order mandating that a particular individual not come closer that a certain distance to some other person, physical location, or some combination thereof. However, such mandates are difficult to enforce. Law enforcement almost always lacks the resources to monitor such individuals to ensure compliance. Typically, law enforcement only learns that a protective order has been violated after the fact. This is often too late for the person or property the protective order was issued to protect.

Using a system 10 in accordance with the present invention, both the person to whom the protective order applies as well as the person or property for which protection is sought may be equipped with beacons 12. Accordingly, an application module 290 may be programmed to send a communication (e.g., alarm) to an appropriate location (e.g., client 18) whenever the beacon 12 corresponding to the restrained individual passes within a certain distance of a beacon 12 corresponding to an object or person being protected.

Additionally, a beacon 12 may detect when it has been compromised (e.g., removed from the wrist, ankle, or the like of the individual subject to the order). Such information may be communicated to the appropriate client 18. Moreover, an application module 290 may be programmed to detect unusual behavior. For example, in view of past history, an application module 290 may detect when a beacon 12 has remained stationary for an excessive period of time.

In such embodiments, the relevant law enforcement agency may be the entity operating the system 10. Alternatively, the law enforcement agency may be a client 18 receiving (e.g., purchasing) information from the entity operating the system 10. Either way, law enforcement personnel may be notified and sent to investigate whenever the information collected so dictates. Due to the real time nature of the system 10, action may be taken to remedy the situation before substantial harm may be done.

### 2. EXAMPLE II

In selected embodiments, a system 10 in accordance with the present invention may be used by law enforcement to regulate parolees. For example, a beacon 12 may be worn by all parolees operating within a system 10. Thus, location information and status information relating to each parolee and corresponding beacon 12 may be collected and reported as desired. Using this information, law enforcement agencies may ensure that parolees do not go to locations likely to give rise to unlawful conduct or otherwise violate the terms of their parol.

### 2. EXAMPLE III

In selected embodiments, a system 10 in accordance with the present invention may be used to locate lost persons. For example, before entering a wilderness area, each person within a group may be equipped with a beacon 12. Accordingly, if any members of the group were to become lost, mobile locators 14 may be deployed to the area. In such an embodiment, a stand-alone computer (e.g., laptop) may function as the server 16 reporting location and status information directly to any operator thereof.

If desired, beacons 12 for such excursions may be purchased as a nominal cost. As a result, the probability they will be purchased and worn may be greatly increased. The costs of deploying locators 14 and collecting location and status information may then be covered by some responsible entity. Alternatively, the cost of the beacons 12 may be increased somewhat and act as an insurance premium. That is, the revenue collected from sales of the beacons 12 may be used to cover the costs associated with the occasional deployment of locators to locate lost persons.

The present invention may be embodied in other specific forms without departing from its basic structures or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A system comprising:
a transmitter periodically transmitting a packet via electromagnetic radiation, the packet encoded with information and having a length measured in time; and
a receiver comprising:
an antenna converting incident electromagnetic radiation to an analog electrical current; and
an analog-to-digital converter receiving the analog electrical current and producing a digital representation thereof;
first and second buffers, each buffer having a capacity of at least two times the length of the packet, the first and second buffers storing respective first and second copies of the digital representation, the first copy being offset in time from the second copy by at least the length of the packet.

2. The system of claim 1, wherein the packet has a length in the range of about one millisecond to about two milliseconds.

3. The system of claim 2, wherein the first and second buffers each have a storage capacity corresponding to about two times the length of the packet.

4. The system of claim 3, wherein the analog-to-digital converter samples the analog electrical current about twenty times per the chip rate of the packet.

5. The system of claim 3, wherein the receiver further comprises at least one filter removing out-of-band interference from the analog electrical current, the at least one filter positioned between the antenna and the analog-to-digital converter.

6. The system of claim 5, wherein the receiver further comprises a mixer changing the carrier frequency of the analog electrical current to an intermediate frequency while preserving the phase information of the analog electrical current, the mixer positioned between the at least one filter and the analog-to-digital converter.

7. The system of claim 6, wherein the receiver further comprises a jamming detector collecting information corresponding to jamming signals.

8. The system of claim 1, wherein the first and second buffers each have a storage capacity corresponding to about two times the length of the packet.

9. The system of claim 1, wherein the analog-to-digital converter samples the analog electrical current about twenty times per the chip rate of the packet.

10. A system comprising:
a transmitter connected to an entity and periodically transmitting a packet via electromagnetic radiation, the packet having a length measured in time and comprising psuedo noise and an encoded identification corresponding to the entity; and
a receiver comprising:
an antenna converting incident electromagnetic radiation to an analog electrical current; and
an analog-to-digital converter receiving the analog electrical current and producing a digital representation thereof;
first and second buffers, each buffer having a capacity of at least two times the length of the packet, the first and second buffers storing respective first and second copies of the digital representation, the first copy being offset in time from the second copy by at least the length of the packet.

11. The system of claim 10, wherein the entity is a human being.

12. The system of claim 10, wherein the packet further comprises encoded entity information corresponding to a condition of the entity.

13. The system of claim 10, wherein the packet further comprises encoded transmitter information corresponding to a condition of the transmitter.

14. The system of claim 10, wherein the transmitter is connected to the entity by a tether.

15. The system of claim 14, wherein the packet further comprises encoded tether information corresponding to a condition of the tether.

16. The system of claim 15, wherein the entity is a human being and the tether comprises a band encircling one of the wrist and ankle of the human being.

17. A system comprising:
a transmitter periodically transmitting, via electromagnetic radiation, a packet having a length measured in time;
a receiver comprising:
an antenna converting incident electromagnetic radiation to an analog electrical current;
an analog-to-digital converter receiving the analog electrical current and producing a digital representation thereof; and
first and second buffers, each buffer having a capacity of at least two times the length of the packet, the first and second buffers storing respective first and second copies of the digital representation, the first copy being offset in time from the second copy by at least the length of the packet; and
a digital signal processor receiving the outputs of the first and second buffers.

18. The system of claim 17, wherein the receiver further comprises a jamming detector collecting information corresponding to jamming signals and delivering the information to the digital signal processor.

19. The system of claim 18, wherein the digital signal processor is programmed to perform a fast Fourier transform on the jamming signals to detect the frequency and amplitude thereof, attenuate the frequencies corresponding to the jamming signals, and perform an inverse Fourier transform on the resulting signals.

20. The system of claim 17, wherein the digital signal processor is programmed to correlate the first and second copies of the digital representation to locate, decode, and determine the time-of-arrival of the packet.
